(19) United States
(12) Patent Application Publication
(10) Pub. No.: US 2006/0252453 A1
(43) Pub. Date: Nov. 9, 2006

(54) Apparatus and system for integrating telecommunications networks

(75) Inventor: Shui-Ho Hung, Taipei (TW)

Correspondence Address: Howard Chen, Esq.;Preston Gates & Ellis LLP, Suite 1700, 55 Second Street, San Francisco, CA, 94105, US

(73) Assignee: VIA Technologies, Inc.

(21) Appl. No.: 11/418,716

(22) Filed: May 4, 2006

Related U.S. Application Data
(60) Provisional application No. 60/678,038, filed on May 5, 2005.

(51) Int. Cl. H04M 1/00

(52) U.S. Cl. 455/552.1; 455/553.1

(57) ABSTRACT

An apparatus for integrating various telecommunications systems includes a processor, a first connector for connecting the processor to a fixed-line telephone, a second connector for connecting the processor to a fixed-line operator, and a third connector for connecting the processor to the Internet. The processor is controlled to direct an incoming phone call received from the fixed-line operator or the Internet to the fixed-line telephone.

### CROSS REFERENCE

The present application claims the benefits of U.S. Patent Provisional Application No. 60/678,038, which was filed on May 5, 2005.

### FIELD OF THE INVENTION

The present invention relates generally to telecommunications technology, and more particularly to an apparatus and system for integrating various telecommunications networks.

### BACKGROUND

As telecommunications technology develops, there are various types of networks, through which telecommunications signals can be transmitted. The public switched telephone network (PSTN) is a collection of the world's public circuit-switched telephone networks, which are comprised of fixed-line analog or digital telephone systems that deliver fixed telephone service to the general public. The telecommunications signals can also be transmitted through a wireless telecommunications network based on various systems, such as a code division multiple access (CDMA) system and global system for mobile communications (GSM) system. Voice conversation data can also be routed through an Internet Protocol (IP) based network, instead of traditional dedicated, circuit-switched voice transmission lines. This is known as the voice over Internet Protocol (VoIP) network.

Due to the variety of the telecommunications systems, routing a phone call through various systems can be quite complicated. Nowadays, a user often has a plurality of phone numbers and IDs for various telecommunications networks. The user may have a phone number for a fixed-line telephone at home, another number for his mobile phone, and an instant messenger ID for sending voice data and instant messages through a VoIP network. These phone numbers and IDs can be quite difficult to manage. For example, a user may miss an incoming call directed to his fixed-line telephone, if he is away from the location where the telephone is at, or the user may miss an incoming call directed to his instant messenger ID, if his instant messenger program is not activated. Moreover, the user may prefer to use one telecommunications system over another. For example, the user may want to use his home phone, instead of his mobile phone, as a primary device to receive incoming phone calls when he is at home in order to save money for phone bills.

As such, what is needed is an apparatus and system for integrating various telecommunications systems, such that the user can better manage his multiple phone numbers and IDs.

### SUMMARY

The present invention discloses an apparatus for integrating various telecommunications systems. In one embodiment of the present invention, the apparatus includes a processor, a first connector for connecting the processor to a fixed-line telephone, a second connector for connecting the processor to a fixed-line operator, and a third connector for connecting the processor to the Internet. The processor is controlled to direct an incoming phone call received from the fixed-line operator or the Internet to the fixed-line telephone.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 illustrates an example of how a telecommunications system receives an incoming phone call in accordance with one embodiment of the present invention.

FIG. 2 illustrates another example of how a telecommunications system receives an incoming phone call in accordance with another embodiment of the present invention.

FIG. 3 illustrates an example of how a telecommunications system routes an outgoing phone call in accordance with another embodiment of the present invention.

FIG. 4 illustrates another example of how a telecommunications system routes an outgoing phone call in accordance with another embodiment of the present invention.

FIG. 5 illustrates an example of how a telecommunications system routes an outgoing phone call using a two-stage method in accordance with another embodiment of the present invention.

FIG. 6 illustrates another example of how a telecommunications system routes an outgoing phone call using a two-stage method in accordance with another embodiment of the present invention.

FIG. 7 illustrates an apparatus for integrating various telecommunications networks in accordance with one embodiment of the present invention.

FIG. 8 illustrates an apparatus for integrating various telecommunications networks in accordance with another embodiment of the present invention.

### DESCRIPTION

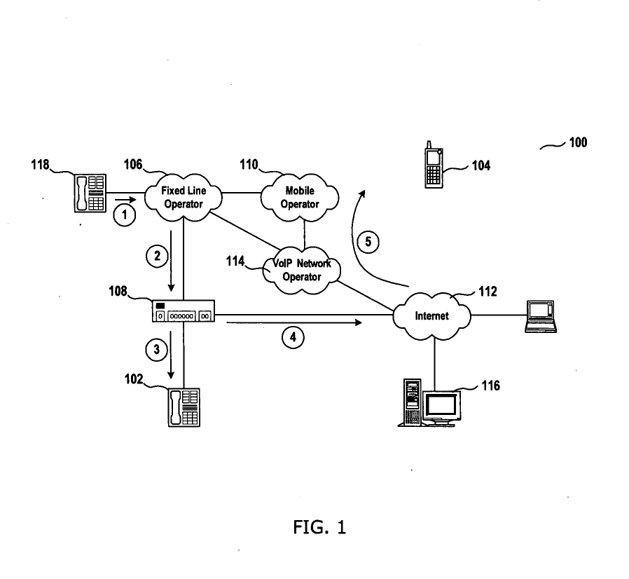

FIG. 1 illustrates an example of how a telecommunications system 100 receives an incoming phone call in accordance with one embodiment of the present invention. In the system 100, a receiving end has two telecommunications devices, one fixed-line telephone 102 and one mobile phone 104. The fixed-line telephone 102 is connected to a fixed-line operator 106 via a router 108. The fixed-line operator 106 is further connected to a mobile operator 110 that is capable of transmitting and receiving signals to and from the mobile phone 104. The router 108 is also connected to the Internet 112, which can interface with the fixed-line operator 106 and the mobile operator 110 through a VoIP network operator 114. There are currently many VoIP networks available. One of the most popular VoIP networks is Skype, which not only allows users to send and receive instant messages with computers, but also allows users to place and receive phone calls (Skype-Out, Skype-In) over the Internet. A phone ID server 116 that stores a user's multiple phone numbers and IDs can be accessed by the user through the Internet 112. The phone ID server 116 allows the user to program the order for his telecommunications devices to receive incoming phone calls, thereby allowing the user to manage his multiple telecommunications devices efficiently. The detailed functions of the phone ID server 116 will be further explained below.

The user can receive an incoming phone call by both the fixed-line telephone 102 and the mobile phone 104. For example, if the incoming phone call is initiated by a fixed-line telephone 118, the router 108 will receive the incoming phone call from the fixed-line operator 106 and forward it to the fixed-line telephone 102, and to the mobile phone 104 via the Internet 112, the VoIP network operator 114 and the mobile operator 110. In other words, when there is an incoming phone call, both the fixed-line telephone 102 and mobile phone 104 will ring. This reduces the chance for the user to miss incoming phone calls. The router 108 also allows the user to set up a call receiving order for the fixed-line telephone 102 and the mobile phone 104. For example, the user can set up the fixed-line telephone 102 to ring first and the mobile phone 104 to ring later, notwithstanding whether the incoming call is initially directed to the fixed-line telephone 102 or mobile phone 104. This allows the user to choose his fixed-line telephone 102 as a primary device to receive phone calls. As the fixed-line telephone 102 is often more economical to use than the mobile phone 104, the feature of arranging the ring order helps the user save money on phone bills.

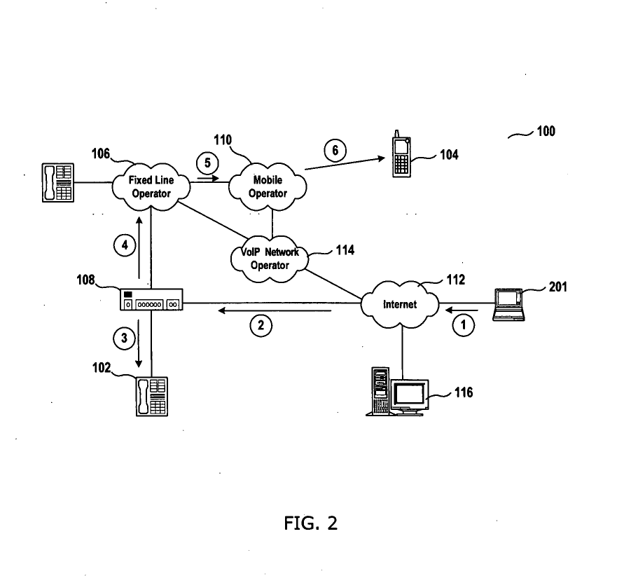

FIG. 2 illustrates another example of how the telecommunications system 100 receives an incoming phone call in accordance with another embodiment of the present invention. An incoming phone call is initiated by a computer 201, which is installed with certain application programs that allow the computer 201 to direct a call to a traditional telephone or mobile phone. The phone call is transmitted over the Internet 112 to the router 108, which automatically forward, the call to the fixed-line telephone 102 and to the mobile phone 104 via the fixed-line operator 106 and the mobile operator 110. This allows a caller using a computer to place a phone call, without subscribing commercial VoIP services. Whether the fixed-line telephone 102 or the mobile phone 104 rings first can be set up by the router 108.

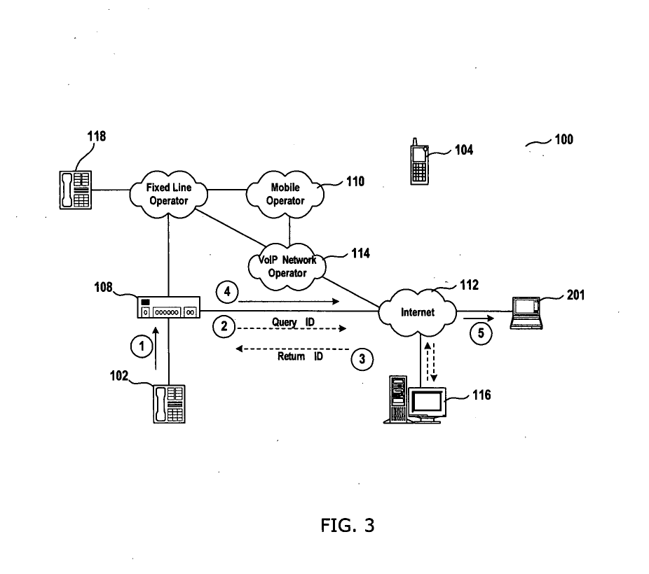

FIG. 3 illustrates an example of how the telecommunications system 100 routes an outgoing phone call in accordance with another embodiment of the present invention. In this example, a phone call placed by the fixed-line telephone 102 can be received by the computer 201. The router 108 receives the phone call from the fixed-line telephone 102, and queries phone ID server 116 for a phone ID corresponding to the number dialed by the fixed-line telephone 102. The phone ID can be an ID of instant messenger software installed in the computer 201. The user pre-programs the phone ID with a corresponding traditional phone number in the phone ID server 116. When the user dials the phone number with the fixed-line telephone 102, the router 108 retrieves its corresponding phone ID from the phone ID server 116, such that the receiver can receive the phone call with the computer 201.

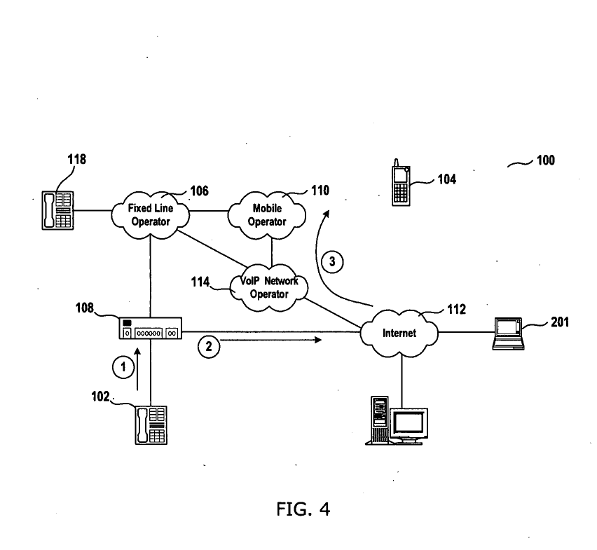

FIG. 4 illustrates another example of how the telecommunications system 100 routes an outgoing phone call in accordance with another embodiment of the present invention. In this example, the router 108 directs a phone call initiated by the fixed-line telephone 102 to the mobile phone 104 through the Internet 112, the VoIP network operator 114, and the mobile operator 110. This can save the user money on phone bills. The cost of routing the phone call to the mobile phone operator 110 through the Internet 112 and VoIP network operator 114 is cheaper than through the fixed-line operator 106. The cost difference is significant, especially when the fixed-line telephone 102 and the mobile phone 104 are to be connected internationally.

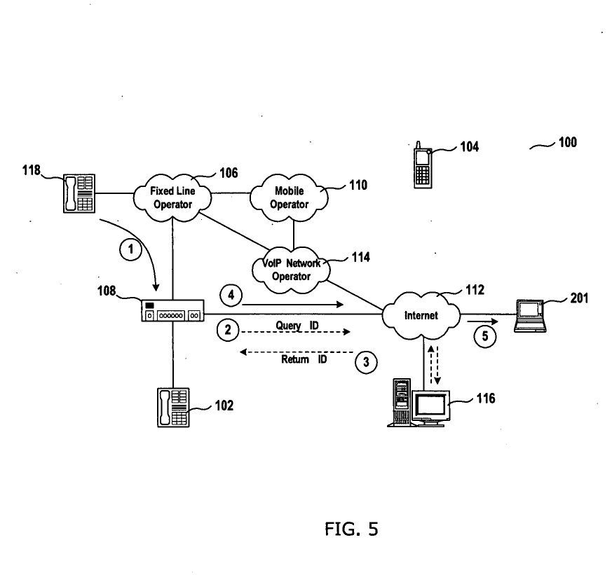

FIG. 5 illustrates an example of how the telecommunications system 100 routes an outgoing phone call using a two-stage method in accordance with another embodiment of the present invention. In this example, a phone call is initiated by a fixed-line telephone 118, which is connected to the router 108 via the fixed-line operator 106. The router 108 queries phone ID server 116 for a phone ID corresponding to the number dialed by the fixed-line telephone 118. The phone ID can be an ID of instant messenger software installed in the computer 201. The user pre-programs the phone ID with a corresponding traditional phone number in the phone ID server 116. When the user dials the phone number with the fixed-line telephone 118, the router 108 retrieves its corresponding phone ID from the phone ID server 116, such that the receiver can receive the phone call with the computer 201. The two-stage dialing feature allows the user to direct a phone call from the remote fixed-line telephone 118 to the computer 201 using the router 108, even though the telephone 118 is not connected to the router 108 directly.

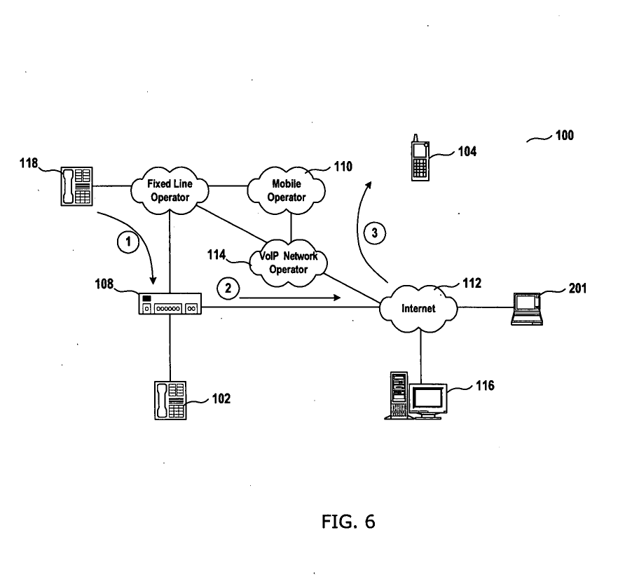

FIG. 6 illustrates another example of how the telecommunications system 100 routes an outgoing phone call using a two-stage method in accordance with another embodiment of the present invention. In this example, a phone call is initiated by a fixed-line telephone 118, which is connected to the router 108 via the fixed-line operator 106. The router 108 directs the phone call to the mobile phone 104 through the Internet 112, the VoIP network operator 114, and the mobile operator 110. This can save the user money on phone bills. The cost of routing the phone call to the mobile phone operator 110 through the Internet 112 and VoIP network operator 114 is cheaper than through the fixed-line operator 106. The cost difference is significant, especially when the fixed-line telephone 118 and the mobile phone 104 are to be connected internationally. The two-stage dialing feature allows the user to direct a phone call from the remote fixed-line telephone 118 to the mobile phone 104 using the router 108, even though the telephone 118 is not connected to the router 108 directly.

As discussed above, the router can direct an incoming phone call to multiple call receiving devices, such as fixed-line telephones, mobile phones and computers, at the same time, thereby reducing the chance of missing phone calls. The order of which call receiving device rings first can be set up by the router based on the user's preference. The router 108 can be controlled by a remote telephone. A number of phone numbers and IDs can be pre-programmed in a phone ID server for the router 108 to retrieve when a phone call is to be routed among various phone systems. The server can be maintained by a third party that provides such phone number listing services on a fee or non-fee basis. The following list is an example of the phone numbers and IDs stored in the server.

TABLE 1

| | | Phone-2 | Phone-3 | Phone-4 | Phone-5 | Phone-6 |
|---|---|---|---|---|---|---|
| | | Taiwan | Japan | USA | USA | China |
| Name | Skype ID | Mobile Phone | Mobile Phone | Office | Mobile | Mobile |
| David_Wu | Va12345japan | 0936- | 002-81-90- | 002-1- | 002-1- | 002-86- |
| | | 543279 | 912345678 | 515-1234567 | 90865431 | 139-12345678 |

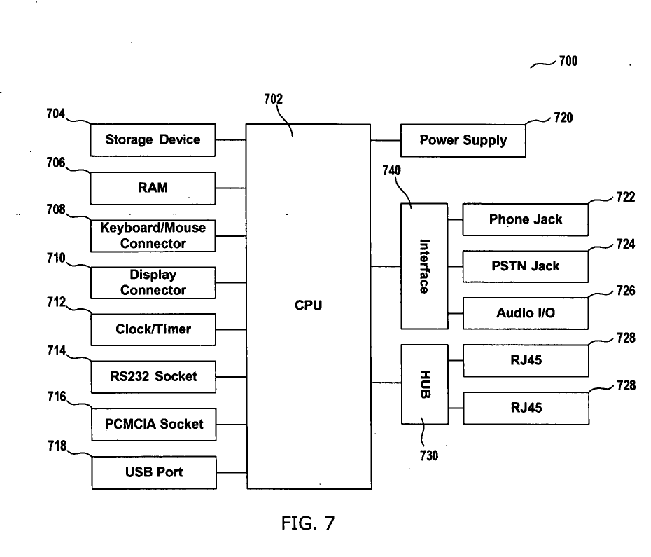

FIG. 7 illustrates a block diagram 700 of the router shown in the previous drawings in accordance with one embodiment of the present invention. The router includes a CPU 702 coupled to a storage device 704, random access memory 706, keyboard/mouse connector 708, display connector 710, clock/timer 712, RS232 socket 714, PCMCIA socket 716, and USB port 718. The storage device 704 can be a non-volatile memory such as flash memory. The keyboard/mouse connector 708 and displayer connector 710 connect the CPU 702 to an input device and display, respectively. The clock/timer 712 indicates time for the CPU 702. The RS 232 socket 714, PCMCIA socket 716, and USB port 718 connect the CPU 702 to peripheral devices. The power supply 720 provides the CPU 702 with power. A phone jack 722, PSTN jack 724, and audio I/O 726 are connected to the CPU 702 via an interface 740. The phone jack 722 allows a fixed-line telephone 102 to be connected to the router 108. The PSTN jack 724 allows the router 108 to be connected to a fixed-line operator 106. The audio I/O 726 inputs and outputs voice data into and from the CPU 702 via the interface 740. One or more RJ 45 connectors 728 are coupled to the CUP 702 through a hub 730 for connecting the CPU 702 to the Internet 112. Application software can be programmed in the storage device 704 for controlling the CPU 702 to route the voice data among various telecommunications devices, such as fixed-line telephones, mobile phones and computers.

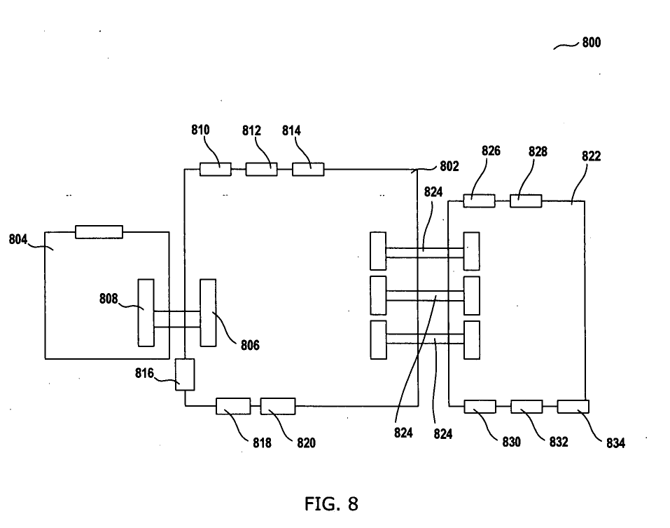

FIG. 8 illustrates a circuit layout 800 of the router shown in the previous drawings in accordance with one embodiment of the present invention. A first circuit board 802 is connected to a power supply 804 via connectors 806 and 808. The power supply 804 has an AC power connector that can be connected to a regular household AC power socket. The first circuit board 802 includes an RS232 socket 810, two RJ 45 jacks 812 and 814, and a PCMCIA socket 816. The first circuit board 802 also has a power indicator 818 and a network indicator 820 for indicating the status of power supply and network connection. The first circuit board 802 is connected to a second circuit board 822 via various links, such as RS232 data, audio, and power links. The second circuit board 822 includes a phone jack 826 and a PSTN jack 828. The second circuit board 822 also includes a phone indicator 830, PSTN indicator 832 and IP indicator 834 for indicating the status of various lines connected to the circuits boards. It is noted that the circuit modules, such as a CPU, storage device, and RAM, are not shown in this figure for purpose of simplicity.

The present invention discloses a router for integrating various telecommunications systems and networks. A number of telecommunications devices, such as a fixed-line telephone, mobile phone and computer, can be connected to the router. When the router receives an incoming phone call, it will direct the call to all of the devices. This reduces the chance of a missing phone call. An order of which device rings first can be programmed in the router for helping the user save money on phone bills. A list containing the phone numbers and IDs for a user can be stored in a phone ID server connected to the router through the Internet, such that a phone call placed by a traditional phone can be received by a computer via the router assisted by the server. The router can also be controlled remotely. Thus, the user can initiate a phone call using a remote telephone, and have the call directed to multiple receiving devices through the router.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. An apparatus for integrating various telecommunications systems, comprising:
a processor;
a first connector for connecting the processor to a fixed-line telephone;
a second connector for connecting the processor to a fixed-line operator;
a third connector for connecting the processor to the Internet; and
wherein the processor is controlled to direct an incoming phone call received from the fixed-line operator or the Internet to the fixed-line telephone.

2. The apparatus of claim 1 wherein the processor is controlled to direct an incoming phone call received from the fixed-line operator to a mobile phone via a VoIP network operator and a mobile operator through the Internet.

3. The apparatus of claim 1 wherein the processor is controlled to direct an incoming phone call received from the Internet to a mobile phone though the fixed-line operator and a mobile operator.

4. The apparatus of claim 1 wherein the processor is controlled to direct an outgoing phone call initiated by the fixed-line telephone to a computer through the Internet.

5. The apparatus of claim 4 wherein the processor is controlled to retrieve a phone ID corresponding to the outgoing phone call from a phone ID server through the Internet.

6. The apparatus of claim 1 wherein the processor is controlled to direct an outgoing phone call initiated by the fixed-line telephone to a mobile phone via a VoIP network operator and a mobile operator through the Internet.

7. The apparatus of claim 1 wherein the processor receives an outgoing phone call initiated by a remote telephone via the fixed-line operator, and directs the outgoing phone call to a mobile phone via a VoIP network operator and a mobile operator through the Internet.

8. The apparatus of claim 1 wherein the processor receives an outgoing phone call initiated by a remote telephone via the fixed-line operator, and directs the outgoing phone call to a computer through the Internet.

9. The apparatus of claim 8 wherein the processor is controlled to retrieve a phone ID corresponding to the outgoing phone call from a phone ID server through the Internet.

10. A server connected to a router, which directs an incoming or outgoing phone call to a plurality of call receiving devices through various telecommunications systems, the server comprising:
at least one list of phone numbers and IDs that can be retrieved by the router through the Internet for converting a phone number of a first telecommunications system to a phone ID of a second telecommunications system, thereby allowing the router to direct a phone call initiated by a first device of the first telecommunications system to a second device of the second telecommunications system, or vice versa.

11. The server of claim 10 wherein the first telecommunications system is a fixed-line telephone network.

12. The server of claim 10 wherein the second telecommunications system is a VoIP network.

13. The server of claim 10 wherein the first device is a fixed-line telephone.

14. The server of claim 10 wherein the second device is a computer.

15. An apparatus for integrating various telecommunications systems, comprising:
a processor;
a first connector for connecting the processor to a fixed-line telephone;
a second connector for connecting the processor to a fixed-line operator;
a third connector for connecting the processor to the Internet; and
wherein the processor is controlled to direct an incoming phone call received from the fixed-line operator or the Internet to the fixed-line telephone,
wherein the processor is controlled to direct an outgoing phone call initiated by the fixed-line telephone to a computer through the Internet or to a mobile phone via a VoIP network operator and a mobile operator through the Internet.

16. The apparatus of claim 15 wherein the processor is controlled to direct an incoming phone call received from the fixed-line operator to a mobile phone via the VoIP network operator and the mobile operator through the Internet.

17. The apparatus of claim 15 wherein the processor is controlled to direct an incoming phone call received from the Internet to a mobile phone though the fixed-line operator and the mobile operator.

18. The apparatus of claim 15 wherein the processor is controlled to retrieve a phone ID corresponding to the outgoing phone call from a phone ID server through the Internet.

19. The apparatus of claim 15 wherein the processor receives an outgoing phone call initiated by a remote telephone via the fixed-line operator, and directs the outgoing phone call to a mobile phone via the VoIP network operator and the mobile operator through the Internet.

20. The apparatus of claim 15 wherein the processor receives an outgoing phone call initiated by a remote telephone via the fixed-line operator, and directs the outgoing phone call to a computer through the Internet.
